(19) United States
(12) Patent Application Publication
(10) Pub. No.: US 2025/0002172 A1
(43) Pub. Date: Jan. 2, 2025

(54) Method for determining an emergency landing track, corresponding device and computer program

(71) Applicant: THALES, Meudon (FR)

(72) Inventors: Denis RICAUD, TOULOUSE (FR); Johan BOYER, TOULOUSE (FR); Laurent FREDE, TOULOUSE (FR)

(21) Appl. No.: 18/751,271

(22) Filed: Jun. 23, 2024

(30) Foreign Application Priority Data
Jun. 29, 2023 (FR) 2306898

(51) Int. Cl. B64D 45/04; G01C 21/20

(52) U.S. Cl. CPC B64D 45/04; G01C 21/20

(57) ABSTRACT

A method for determining a runway to be used for making an emergency landing, implemented in flight by an electronic device on-board an aircraft. The method includes at least one iteration of (i) obtaining, from on-board equipment of the aircraft, data representative of current wind characteristics, at a current altitude of the aircraft, and (ii) determining a runway to be used for the emergency landing, based on data representative of current wind characteristics at current altitude, based on a set of preselected runways, and based on a structure of correlation data between the data representative of wind characteristics at the current altitude and data representative of runways in service on the ground.

### CROSS-REFERENCE TO RELATED APPLICATIONS

This application is a U.S. non-provisional application claiming the benefit of French Application No. 23 06898, filed on Jun. 29, 2023, which is incorporated herein by reference in its entirety.

### TECHNICAL FIELD OF THE INVENTION

The invention relates to the field of air navigation. The invention relates more particularly to the field of aircraft flight planning. The invention aims more particularly at determining, for a given flight plan, one or a plurality of contingency runways which can be used.

### BACKGROUD OF THE INVENTION

When implementing air navigation operations, the definition of a flight plan is a pre-flight operation to the air transport operation as such. The definition of a flight plan serves in particular to plan a dialog with the navigation controllers on the ground. The flight plan contains information on the identity and features of the aircraft, the number of persons on-board, the description of the flight path, etc. In commercial transport operations, a repetitive flight plan (RPL) is used by airlines to describe regular flights. For the implementation of a commercial air transport operation, it is assumed that the flight crew, usually composed of a pilot and a co-pilot, follows the flight plan that has been established. If, during the course of the transport operation, one of the crew members (the pilot or the co-pilot) is physically unable to carry out the operations for which he or she is responsible (e.g., due to a malaise), the remaining flight personnel are expected to be able to continue flight operations and/or to identify, in contact with ground control, a diversion airport and a runway so that the aircraft can land urgently if the need arises.

In the case of single pilot commercial flight operations (also known as SPO for Single Pilot Operation), a pilot's incapacity raises significantly more difficulties. Indeed, since there is no co-pilot, a pilot who is unable to continue the flight operations leaves to the computerized management systems of the aircraft, the technical responsibility for taking over the flight operation and for landing the aircraft in conditions of maximum safety and in a relatively short period of time.

To date, computerized flight management systems exist, such as the FMS (Flight Management System), which are apt to manage phases of commercial transport operations autonomously (either alone or in coordination with other computerized aircraft subsystems), such as taxiing, take-off, cruising and landing. More particularly, the computerized system of the aircraft is apt to perform the technical operations related to the phases. Once placed on the runway, the computerized system is able to perform the take-off; once established on the appropriate landing procedure (to land on the runway that has been assigned to the pilot by ground control), e.g., when a number of ground equipment items (category III ILS (Instrument Landing System)) and conditions are met (specific to the aircraft, the crew, and to the state of the systems and to the external conditions, in particular wind) the computerized system is apt to perform the take-off.

However, the situation is different when the only pilot on-board is not able to establish a link with ground control. The computer system has then not only to determine alone on which airport the emergency landing is to be made, but also to determine the runway on which the landing is to be made.

It is recalled that an aircraft flies, takes off and lands as long as the speed of movement of the aircraft relative to the air is greater than the stall speed (minimum air speed which depends to 1^{st} order on the configuration of the aircraft—i.e., the state of deployment of landing gear, wing slats and flaps) thereof. At landing, the speed of the aircraft relative to the ground is reduced if, in a terrestrial reference frame, the mass of air in which the aircraft is flying moves in a direction opposite to the movement of the aircraft (in other words, if the aircraft arrives for landing with a headwind component). The ideal is to take off or land with a headwind (most aircraft nevertheless have a declared flight domain that allows same to land and take off in tailwind conditions, but for fairly limited wind values). The single or main runway of an airport is thus generally oriented along the direction of the prevailing wind. When the wind speed is not aligned with the direction of the runway, the aircraft has to take off or to land with a crosswind component, the maximum allowable value of which is determined by the manufacturer (as for headwind and tailwind). To allow operation regardless of wind direction, some airports have one or two additional runways forming an angle of approximately 90° or 60° therebetween. In the case of an emergency landing in automatic mode, it is necessary for the aircraft to be able to land in a upwind in order to limit the risks of exiting the runway, i.e., the risks of exceeding the maximum landing distance of the runway.

However, there is currently no way to easily and automatically determine the runway on which the automatic emergency landing may be made safely.

### SUMMARY OF THE INVENTION

The goal of the invention is to remedy such drawback and in particular to enable automatic determination of the runway on which the automatic emergency landing may be carried out, completely safely. More particularly, the invention relates to a method for determining a runway to be used to effect an emergency landing, which method to be implemented in flight by an electronic device on-board an aircraft. Such a method includes at least one iteration of the following operations:
obtaining, from an aircraft on-board, data representative of current wind characteristics at a current altitude of the aircraft; and
determination of a runway to be used for the emergency landing, based on data representative of current wind characteristics at the current altitude, on a set of preselected runways, and based on a structure of correlation data between the data representative of wind characteristics at the current altitude and the data representative of runways in service on the ground.

Thereby, the method of the invention makes it possible, at any instant of the flight, to provide information relating to a runway in service according to conditions which are encountered in full flight, facilitating the implementation of an automatic routing of the aircraft to an emergency landing runway.

According to a particular characteristic, the determination operation includes the following operations:
obtaining, based on the data representative of current wind characteristics at the current altitude and on the structure of the correlation data, a record of data representative of a runway in service on the ground; and
selecting, within the set of preselected runways, based on the recording of data representative of a runway in service on the ground, of the runway to be used for the emergency landing.

Thereby, the method implemented is apt to facilitate identification of the runway in the absence of intervention by a human operator, i.e., without intervention of the pilot or of the copilot of the aircraft.

According to a particular feature, the operation of obtaining a record of data representative of a runway in service on the ground, includes:
an operation of identifying, within the structure of correlation data, at least one record of data representative of the characteristics of the wind on the ground, each record including a probability of compatibility of runway in service and a location area; and
an operation of selecting, from the at least one identified record, a record according to the probability of compatibility of the runway in-service, of the record.

According to a particular characteristic, the selection operation for selecting record is carried out by selecting, from the at least one identified record, the record with the highest probability of compatibility.

According to a particular characteristic, the operation of selecting the runway to be used for making the emergency landing further incudes an operation of obtaining, from equipment situated on the ground, data representative of a runway in service from among the set of preselected runways.

According to a particular feature, the determination method further includes an operation of preselecting, from a list of runways usable for making an emergency landing, the set of preselected landing runways, according to a flight plan of the aircraft.

According to a particular feature, the preselection operation is implemented according to a position of the aircraft, the position being provided by an instrument on-board the aircraft.

According to a particular feature, the data representative of the current characteristics of the wind at the current altitude by the aircraft are obtained from speed, attitude and angle of attack information delivered by at least one piece of equipment on-board the aircraft.

According to a particular feature, the structure of correlation data between the data representative of wind characteristics at the current altitude and the data representative of runways in service on the ground, includes data serving to link the characteristics of wind at altitude with wind characteristics on the ground.

According to another aspect, the invention also relates to an electronic device on-board an aircraft for determining a runway to be used to make an emergency landing. According to the invention, such a device includes:
a module for obtaining, from equipment on-board the aircraft, data representative of current wind characteristics at a current altitude of the aircraft; and
determination of a runway to be used for the emergency landing, based on the data representative of current wind characteristics at the current altitude, based on a set of preselected runways, and based on a structure of correlation data between the data representative of wind characteristics at the current altitude and data representative of runways in service on the ground, the modules being implemented iteratively.

### BRIEF DESCRIPTION OF THE DRAWINGS

The invention will be clearer upon reading the following description, given only as an example, but not limited to, and making reference to the drawings wherein:

FIG. 1 illustrates an electronic device apt to identify an emergency runway based on wind conditions at altitude, in accordance with an embodiment of the present invention;

FIG. 2 illustrates a method of determining an emergency landing runway, in accordance with an embodiment of the present invention; and

FIG. 3 represents how a correlation is made between atmospheric wind conditions and the runway to be selected, in accordance with an embodiment of the present invention.

### DETAILED DESCRIPTION

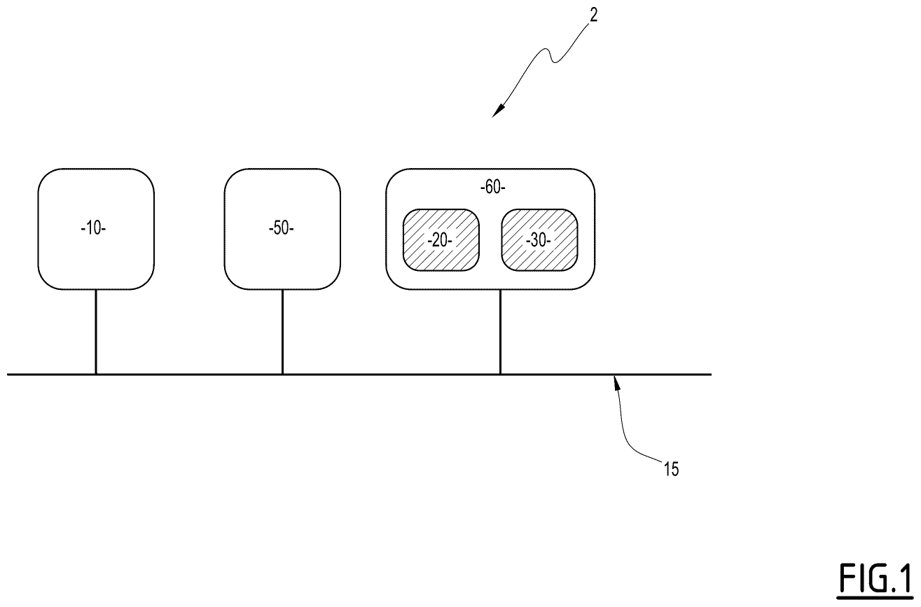

In relation to FIG. 1, an on-board electronic device 2 is presented in an aircraft, for the determination of a runway to be used to make an emergency landing.

In the example shown in FIG. 1, on-board electronic device 2 includes an electronic memory unit 60, at least one calculation processor 50, and an interface 10 for communication with remote devices, such as on-board equipment or a computerized aircraft management system, by a chosen communication protocol, e.g., a wired protocol and/or a radio communication protocol. Elements of device 2 are suitable for communicating via a communication bus 15.

In the example shown in FIG. 1, on-board electronic device 2 includes an acquisition module 20 for acquiring, from equipment on-board the aircraft, data representative of current wind characteristics; and a determination module 30 for determining a runway to be used for making the emergency landing, based on data representative of wind characteristics at the current altitude, based on a set of preselected runways, and based on a structure of correlation data between the data representative of wind characteristics at the current altitude and data representative of runways in service. In the example shown in FIG. 1, the modules are each produced in the form of software, or of a software brick which may be executed by a computation processor 50. Memory 60 of on-board electronic device 2 is then apt to store the corresponding software, and processor 50 is then apt to execute each of the software.

In a variant (not shown), the modules are produced entirely or partially in the form of a programmable logic component, such as an FPGA (Field Programmable Gate Array), or an integrated circuit, such as an ASIC (Application Specific Integrated Circuit), where the component(s) are coupled to processor 50 as described hereinabove.

When on-board electronic device 2 is produced at least in part in the form of one or a plurality of software programs, i.e., in the form of a computer program, also called a computer program product, same is further apt to be recorded on a computer-readable medium (not shown). The computer-readable medium is, e.g., a medium apt to store the electronic instructions and to be coupled to a bus of a computer system. As an example, the readable medium is an optical disk, a magneto-optical disk, a ROM, a RAM, any type of non-volatile memory (e.g., FLASH or NVRAM) or a magnetic card. A computer program containing software instructions is then stored on the readable medium.

Embodiments of the present invention serve to give an aircraft flight computerized system the ability to determine, in real time, the most appropriate runway for an emergency landing. On-board electronic device 2 makes it possible, in the case of flight operation with a two-person flight crew, to facilitate management operations for the emergency landing. On-board electronic device 2 allows, in the case of a flight operation with a flight crew composed of only one pilot, an automatic emergency landing, e.g., when the pilot is unable to conduct the landing operation, but also to facilitate management operations for the emergency landing (if the only pilot is not in a disability situation). On-board electronic device 2 contributes to making it possible, in all cases, to automatically manage a phase of gathering together the procedures suited to the runway in service in preparation for the landing of an aircraft. The aircraft is, e.g., an airplane such as a commercial airliner. In a variant, the aircraft is a business airplane, a private airplane classified in the general aviation category, a helicopter, a drone which may be remotely piloted by a pilot, or else an autonomous aircraft without an operator.

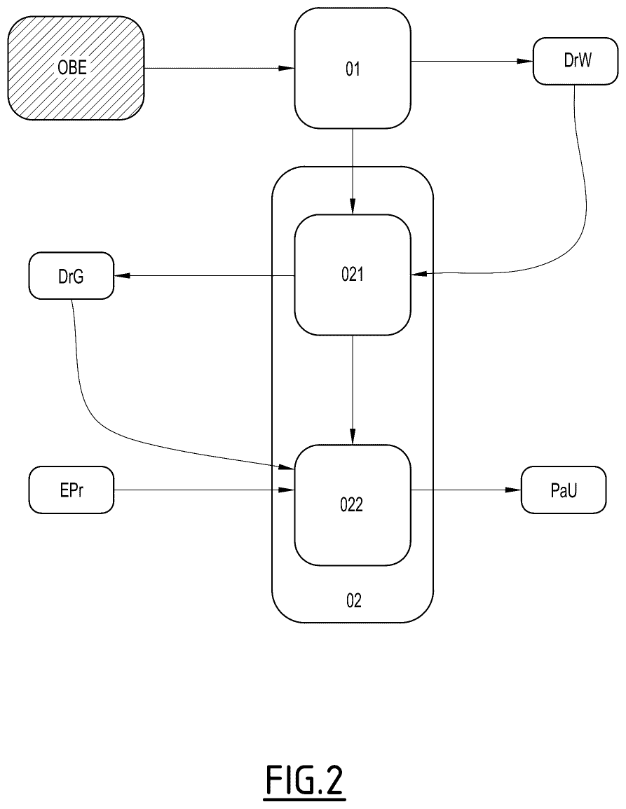

A method of determining a runway to be used for an emergency landing is presented in relation to FIG. 2. The method is implemented in flight by on-board electronic device 2 within an aircraft, which may be distinct or integrated within an aircraft management system (e.g., within a main computer or another equipment, such as a flight management system (FMS)). The method includes at least one iteration of the following operations:
Obtaining 01, from an aircraft on-board equipment (OBE), data representative of current wind characteristics (DrW) at a current altitude of the aircraft; and
Determining 02 a runway to be used for the emergency landing, PaU, based on the data representative of wind characteristics at the current altitude DrW, on a set of preselected runways, Epr, and based on a structure of correlation data, TR, between data representative of wind characteristics at the current altitude DrW and data representative of runways service on the ground.

The preselected runways are, e.g., runways of airports located close to the flight plan of the aircraft, as defined prior to take-off. Moreover, the number of preselected runways may be reduced depending on other factors as the flight progresses, such as, e.g., a deterioration of weather conditions or an else distance outside the range of action of the aircraft. More particularly, in an example of embodiment, the determination operation 02 of determining runway PaU to be used for an emergency landing includes:
Acquiring 021, based on the data representative of wind characteristics at the current altitude DrW and based on the structure of correlation data TR, a record of data representative of a runway in service on the ground DrG; and
Selecting 022, within the set of preselected runways Epr, based on data representative of a runway in service on the ground DrG, the runway PaU to be used for the emergency landing.

Due to such procedure, it is possible, even under little or little-known wind conditions at the departure of the flight, to obtain an indication of a runway to be used in the event of an emergency. For example, data representative of current wind characteristics DrW that are obtained during flight are the current wind speed and/or direction. Such data is then used as a parameter for determining equivalent data encountered on the ground, DrG. Such determination is carried out in particular by using one or a plurality of data structures available to on-board electronic device 2, which serve in particular to link characteristics of the wind at altitude with characteristics of the wind on the ground. The data structures are prepared in advance, on the ground, e.g., within the framework of bulk processing of data sets. Same are then recorded within the aircraft, on a suitable data medium, and may be used by on-board electronic device 2.

In addition, other data structures are also used to record the flight plan and to identify, on that flight plan, a variably large set of runways that may be used as emergency runways on the flight plan. Each of the runways includes in particular at least one location (e.g., in the form of GPS coordinates). The locations serve in particular to determine the distance of the runways with respect to any point of the flight plan planned before take-off.

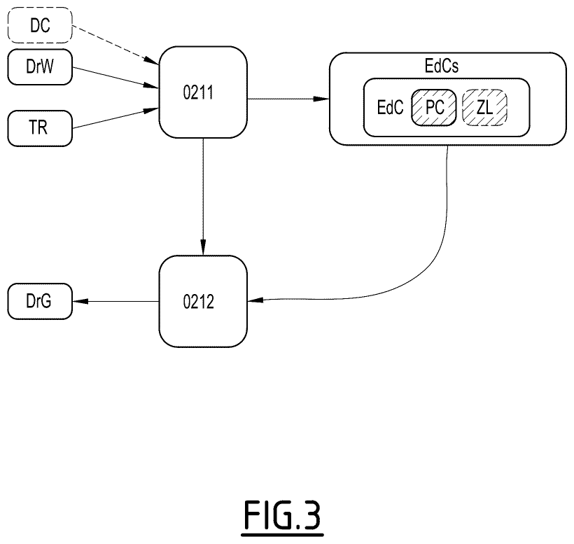

More specifically, in relation to FIG. 3, operation 021 of obtaining data representative of a runway in service on the ground includes:
an identification operation 0211, within the structure of correlation data TR, of at least one record representing data representative of the ground wind characteristics EdCs, each EdC record including a compatibility probability (and optionally a location zone ZL, e.g., in the form of GPS coordinates); the identification is carried out using data representative of the characteristics of the DrW wind at altitude provided as parameters, and optionally of an additional location datum DC, and the identification operation 0211 may only issue one record, depending on the situations.
a selection operation 0212, from the records represents data representative of the ground wind characteristics EdCs, of a record DrG depending on the probability of compatibility associated with the record.

When the identification operation issues only one record, the selection consists of selecting the record. The technique described thereby uses data (in particular data prepared on the ground) serving to establish a level of correlation between:
intensity and direction of the wind, on the ground, at an airport (the airport having been identified before the mission as a possible diversion airport in case of need, because of the proximity thereof to the flight plan); and
intensity and current direction of the wind at the current altitude, on the portion of the main flight plan for which the airport is identified as a diversion airport.

Where it is determined, in an exemplary embodiment, before flight, that an emergency airport includes a runway compatible for an emergency landing, then that airport is selected during the flight if a diversion is required on the flight plan portion in relation to the emergency airport, and it is then suitable to determine, by means of the correlation, the most likely runway “in service” for making the emergency landing.

Determination of the compatible runway may be performed in different ways. For example, determination of a compatible runway may be implemented in two stages, searching within a data structure identifying the runways, in the first place, a runway close to the current position of the aircraft, and secondly by implementing the determination method described hereinabove to determine for the airport which runway is compatible. It is recalled that a runway in service corresponds to an orientation, so that for an airport composed, e.g., of a paved runway length of 1,500 m, there are two runways potentially in service: e.g., a runway 05 (oriented along the direction of 50° from magnetic north) and a runway 23 (oriented along the direction of 230° of the Magnetic North. The two runways are opposite each other but relate to the same strip of bitumen. In the present example, it is assumed that, given the wind encountered at altitude when leaving the initial flight plan to proceed to the pre-identified (pre-selected) emergency airport prior to flight, the probability that it is runway 05 is 70% and the probability that it is runway 23 is hence 30%. Runway 05 is thus retained by the device 2 as an emergency landing runway. In other words, in the first case, device 2 continuously performs a search for a runway close to the position of the aircraft. Device 2 then implements operations for the runway or runways preselected according to the position so as to retain only the runway which has the highest probability. (In the case of equivalent probability, the runway which is the best oriented will be retained, i.e., the one runway that is the most consistent with the direction of the aircraft when same changes course toward the emergency airport). Device 2 may also take into account the preferential runway declared in approach maps, when device 2 has the information numerically.

A second embodiment for determining the compatible runway consists in directly implementing, by the device 2, a selection of a runway with the highest probability of compatibility. Identification operation 0211 may then be carried out within a predetermined range of action with respect to the current position of the aircraft. The range of action is, in the present case, the supplementary location datum DC. in which case the runway with the highest probability of compatibility with ground wind conditions within the predetermined range is selected, even if a closer runway could potentially have been used, but with less probability of favorable ground wind conditions. In other words, in an implementation of the present invention, device 2 identifies a plurality of wind zones that are probably compatible depending on the current position of the aircraft and on a radius of action around the current position. Identification operation 0211 thus provides a plurality of ground wind conditions (and thus a plurality of runways in service), each associated with a position, within a predetermined range of action.

Other methods of determination are, of course, conceivable depending on the operational implementation conditions. In general, device 2 may, e.g., preselect, from the list of runways usable for carrying out an emergency landing, the set of preselected runways, according to a flight plan of the aircraft, and, e.g., depending on the position of the aircraft, the position being provided by an instrument on-board the aircraft.

In addition to the data from the processing of ground wind and altitude data, it is also possible to use other data. In particular, device 2 may recover, before and during a flight, data relating to runways in service, for all or some of the airports situated at a greater or lesser distance from certain points of the flight plan. Indeed, there are data sources relating to runways in service at an airport which serve to supplement the data relating to the probability of runways in service, as calculated in flight. For example, when approaching an airport, the runway in service is generally communicated to the pilot by radio, by ATC (Air Traffic Control) when the aircraft reaches the controlled space and is within VHF radio contact range of the ATC. Moreover, the ATIS (Air Traffic Information Service) is an automatic information system intended for crews, broadcast in a loop on a VHF frequency distinct from that of ATC (with no relation), specific for each airport, which serves to know the latest information to be shared between operational staff on the airport (atmospheric pressure, dew point, visibility, wind intensity and direction, last runway in service). The ATIS message is preferably updated if conditions change and in particular if there is a change of runway. Provided that the ATIS message exists for the diversion airport, same may be received as long as the message is within radio signal range (the range depends on the transmission power, on the distance, on the relief and on reception quality (receiver sensitivity)). Finally, some airports are equipped with D-ATIS (Digital ATIS or Data-Link Automatic Terminal Information Service) which are used to broadcast the same information to be retrieved with on-board connectivity (D-Link AOC, LTE, other). In addition, airports also broadcast, at variably regular intervals, meteorological site observation reports (METAR) that can provide useful data for determining the runway in service (METARs report the force and the direction of the wind. METARs are updated periodically, usually, e.g., every 30 minutes or every 1 hour in France).

Thereby, depending on the available data and on the radio range of the aircraft with respect to the airport, selection operation 022 of selecting, by device 2, runway PaU to be used for making an emergency landing, within the set of preselected runways EPr, depending on data representative of a runway in service on the ground DrG, may also take into account data relating to runways in service:
coming from a D-ATIS message;
by voice recognition on the ATIS frequency (without any impact on the pilot load) when the ATIS radio message is accessible (i.e., within radio range);
by listening to the ATIS message directly by the pilot, when the ATIS Radio message is accessible (i.e., the message is within radio range and a pilot is able to listen to the message); and
by retrieving meteorological observations broadcast, by certain services provided, the availability thereof at the airports concerned (METAR message).

The additional data may be used, depending on the availability thereof, e.g., to refine the selection of the emergency runway. For example, in the presence of a plurality of preselected runways, based on data representative of a runway in service on the ground DrG, the operation 22 of selecting the landing runway PaU includes, e.g., the determination of the runway to be used, based on data representative of a runway in service coming from one of the data sources identified previously. For example, in the presence of a single preselected runway, confirmation of the use of the runway may be made based on data representative of the runway in service coming from one of the sources of supplementary data.

The determination of the wind characteristics on the ground takes into account the determination of the wind characteristics at altitude, as discussed hereinabove. It is recalled that the current characteristics of winds in flight (at altitude) are elaborated in particular from the triangle of speeds. The triangle of speeds is based on obtaining data from on-board equipment that issue:
the TAS (True Air Speed, based on CAS and SAT/OAT serving to know the density of the air, corrected, if appropriate, by a compressibility factor beyond certain speeds) coming from an ADU (Air Data Unit);
the GS (Ground Speed), coming from on-board electronic device 2 GPS or from an inertial unit;
the Heading (coming from a heading unit or an inertial unit); and
the Track (in the same reference frame as the Heading, True or Mag, from on-board electronic device 2 GPS or from an inertial unit).

The speed triangle is used to determine the wind speed and the wind angle and thus to determine the horizontal wind direction at altitude. With regard to the vertical wind at altitude, the latter may also be used as an input parameter for the structure of correlation data. In which case, for the additional datum to be useful, it is advantageous to construct the structure of correlation data by also having a horizontal wind measurement available.

According to the invention, in order to be able to determine the wind conditions encountered on the ground, it is useful to construct, beforehand, one or a plurality of structures of correlation data. The purpose of the structures of correlation data is to link wind conditions on the ground with wind conditions at altitude. To this end, a set of data is prepared, in advance of the phase, from a set of past meteorological observations. More particularly, the preparation includes an operation of collecting, for a given geographical zone (e.g. an airport), a set of given meteorological observations. The observations are ideally collected for a relatively long period of time, e.g., several years. The observations include, in addition to the date and the time, the direction and strength of the wind on the ground (at the airport) and the direction and strength of the wind at different altitudes (e.g., from one thousand to 35 thousand feet, ideally centered around the most frequent cruising altitudes).

The observations are then grouped, e.g., according to the direction (and optionally the force) of the wind encountered at altitude. Observations may also be grouped according to time periods (such as weather seasons, or other appropriate time slices). A plurality of grouping criteria may be applied simultaneously. At the end of the application of the grouping criteria, grouping of meteorological observations are obtained. For each grouping of meteorological observations, metrics are built: the metrics are, e.g., the mean and the standard deviation of the wind direction encountered at altitude, and the mean and the standard deviation of the wind direction encountered on the ground. Such statistics serve, e.g., for a given time period (such as a given week, a given month or a given weather season) to link the flight conditions at altitude with the wind conditions on the ground and to determine a statistic of the involvement of ground conditions according to the conditions at altitude and a statistic relating to the runway in service taking into account the meteorological statistics. Thereby, insofar as the statistics relate to a given airport, it is also determined, according to the observations, which runway is each time the runway in service associated with the groups or the observations.

In another exemplary embodiment, structures of correlation data are built based on the runway in use as the starting point for groupings of weather observations. In such case, observations are grouped according to the runway in service, for the landing (possibly also grouped by time period, as previously). The groupings serve to build statistics relating to weather conditions encountered at altitude, e.g., relating to wind direction and wind force at altitude (if appropriate, by also establishing statistics relating to wind direction and wind force on the ground).

Therefore, from the history of meteorological data on the ground and at altitude, it is possible to build, for each airport (e.g., each airport close to the plan of the different positions of a given flight plan), a structure of correlation data that links mean meteorological conditions at altitude to mean meteorological conditions on the ground and to a corresponding runway in service. It is also possible to directly link mean weather conditions at altitude to a corresponding runway in service at the airport.

Thereby, in a first exemplary embodiment, the structure of correlation data TR may be in the form of a table (e.g., a database table), including a plurality of records. Each record includes, e.g., an average value of the direction and of the orientation of the wind on the ground at the emergency airport (which would optionally depend on the pair (force, direction) of the wind encountered at altitude), according to the conditions of implementation, and an identification of a relative time range (e.g., week, month, weather season). Another type of record takes the form of a probability of a runway (e.g. for runway 05 and runway 23, in the previous example) to be in service, of the emergency airport which would be a function of the pair (force, direction) of the wind encountered at different altitudes flown along the flight plan, over a relative time range (e.g., week, month, weather).

In a second example of embodiment, the structure of correlation data TR may be in the form of a table, including a plurality of records. Each record includes, e.g., a mean value of direction (and optionally a mean value of force) of the wind encountered at altitude and a corresponding runway identifier in service and a probability of correspondence.

1. A method for determining a runway to be used for an emergency landing, implemented in flight, by an electronic device on-board an aircraft, the method comprising at least one iteration of:
obtaining, from on-board equipment of the aircraft, data representative of current wind characteristics, at a current altitude of the aircraft; and
determining a runway to be used for an emergency landing, based on the data representative of current wind characteristics at current altitude, from a set of preselected runways, and based on a structure of correlation data between the data representative of wind characteristics at the current altitude and data representative of runways in service on the ground.

2. The method according to claim 1, wherein said determining comprises:
acquiring, based on the data representative of wind characteristics at the current altitude and based on the structure of correlation data, a record of data representative of a runway in service on the ground; and
selecting, from the set of preselected runways, based on the recording of data representative of a runway in service on the ground, of the runway to be used for the emergency landing.

3. The method according to claim 2, wherein said acquiring comprises:
identifying, within the structure of correlation data, at least one record of data representative of characteristics of wind on the ground, each record comprising a probability of compatibility of a runway in service and a location area; and
selecting, from the at least one identified record, a record according to the probability of compatibility of the runway in service.

4. The method according to claim 3, wherein said selecting comprises selecting, from the at least one identified record, the record with the highest compatibility probability.

5. The method according to claim 2, wherein said selecting further comprises obtaining, from equipment located on the ground, a datum representative of a runway in service among all preselected runways.

6. The method according to claim 1, further comprising preselecting, from a list of runways which may be used for making an emergency landing, a set of preselected runways, according to a flight plan of the aircraft.

7. The method according to claim 6, wherein said preselecting is implemented according to a position of the aircraft, the position being provided by an instrument on-board the aircraft.

8. The method according to claim 1, further comprising obtaining the data representative of the current characteristics of wind at the current latitude by the aircraft, from the speed, attitude and angle of attack information issued by at least one on-board equipment of the aircraft.

9. The method according to claim 1, wherein the structure of correlation data between the data representative of characteristics of the wind at the current altitude and the data representative of runways in service on the ground, comprises data serving to link the characteristics of wind at altitude with the characteristics of wind on the ground.

10. An electronic device on-board an aircraft for the determination of a runway to be used for making an emergency landing, comprising:
an acquisition module acquiring, from aircraft on-board equipment, data representative of current wind characteristics at a current altitude of the aircraft; and
a determination module determining a runway to be used for an emergency landing, based on data representative of current wind characteristics at current altitude, on a set of preselected runways, and based on a structure of correlation data between the data representative of wind characteristics at the current altitude and data representative of runways in service on the ground, the modules being implemented iteratively.

11. A computer program including software instructions which, when executed by a programmable electronic system, implement the method of claim 1.
